(19) United States
(12) Patent Application Publication
(10) Pub. No.: US 2002/0002907 A1
(43) Pub. Date: Jan. 10, 2002

(54) Milk system

(76) Inventor: Robert Brockbank, Kendal (GB)

Correspondence Address: ARENT FOX KINTNER PLOTKIN & KAHN, 1050 CONNECTICUT AVENUE, N.W., SUITE 600, WASHINGTON, DC, 20036, US

(21) Appl. No.: 09/843,138

(22) Filed: Apr. 27, 2001

(30) Foreign Application Priority Data
Apr. 27, 2000 (GB) 0010296.2

(51) Int. Cl. G05D 11/02

(52) U.S. Cl. 99/277.2; 366/153.1

(57) ABSTRACT

A method and apparatus for preparing baby milk by reconstituting the contents of a pack of dry baby milk product in a mixing vessel is disclosed. The method includes the steps of adding water into the vessel until the liquid level reaches a liquid level indicator, adding the contents of the pack into the vessel and screwing a liquid tight lid onto the vessel and agitating the contents thereby reconstituting a volume of baby milk sufficient to make up two or more feeds for infants aged 0 to 24 months.

The present invention relates to the preparation of baby milk and in particular to a new system which can be used to reconstitute dry baby milk accurately and with greater ease.

It is well known that babies and young infants require milk as their staple foodstuff. It is also known to provide dry powdered milk which can be reconstituted as a substitute for natural mother's milk. In the past the preparation of a serving of baby milk such as a baby feed bottle has involved the careful measuring out of a predetermined quantity or volume of dry baby milk product (using a scoop) which has then been reconstituted by adding it to a predetermined quantity of water. This has been necessary to provide milk having the correct consistency and content.

There are inherently some drawbacks with the tin and scoop method of making up bottle feeds. Users preparing the milk may have difficulty in measuring the precise quantity of water required. Of greater concern, when measuring out a scoop of dry milk product, different users inherently use different methods of packing the scoop with powder. This can result in users providing different quantities of dry product despite counting out an identical number of scoops. This problem is described more fully in “Randomised trial of a ready-to-feed compared with powdered formula” Lucas et al; Archives of Disease in Childhood 1992; 67: 935-939. Furthermore some users are tempted to introduce more dry product than is strictly necessary in the belief that this will enhance the baby's satisfaction with the resulting baby milk. This can lead to medical problems (eg diarrhoea) or to excess weight gain for the baby.

The procedure of making up with tin and scoop is also time consuming since each time a feed is required, several scoops must be counted out into a feeding bottle. It is an object of the present invention to at least partly mitigate the above-mentioned problems.

According to one aspect of the present invention there is provided a method of preparing baby milk by reconstituting the contents of a pack of dry baby milk product in a mixing vessel comprising the steps of adding water into the vessel until the liquid level reaches a liquid level indicator, adding the contents of the pack into the vessel, placing a plunger having a baffle plate at an end of a handle into the vessel, and agitating the plunger thereby reconstituting a volume of baby milk which provides sufficient feed for several bottles.

According to a second aspect of the present invention there is provided a method of preparing baby milk by reconstituting the contents of a pack of dry baby milk product in a mixing vessel comprising the steps of adding water into the vessel until the liquid level reaches a liquid level indicator, adding the contents of the pack into the vessel, and screwing a liquid-tight lid onto the vessel and shaking thereby reconstituting a volume of baby milk which exceeds the volume of a baby feed bottle.

According to a third aspect of the present invention there is provided apparatus for preparing baby milk by reconstituting the contents of a pack of dry baby milk product said contents, when correctly reconstituted, having a volume in excess of the volume of a single baby feed bottle, said apparatus comprising a mixing vessel including a level-indicator to indicate when a predetermined volume of water is in the mixing vessel, a lid, and a plunging device which includes a baffle plate disposed at an end of a handle to enable a user to plunge the baffle plate in the mixing vessel; wherein the contents of the pack are mixable with said predetermined volume of water in the mixing vessel to thereby reconstitute the baby milk.

According to a fourth aspect of the present invention there is provided apparatus for preparing baby milk by reconstituting the contents of a pack of dry baby milk product said contents, when correctly reconstituted, having a volume in excess of the volume of a single baby feed bottle, said apparatus comprising a mixing vessel including a level-indicator to indicate when a predetermined volume of water is in the mixing vessel, and a tight fitting lid having a screw thread which can be screwed onto the vessel in a substantially liquid-tight manner; wherein the contents of the pack are mixable with said predetermined volume of water in the mixing vessel to thereby reconstitute the baby milk.

According to a fifth aspect of the present invention there is provided a process of preparing a batch of baby milk comprising weighing a quantity of dry baby milk product which, when correctly reconstituted has a volume in excess of the volume of a single baby feed bottle, packing said weighed quantity in a pack, reconstituting the dry baby milk product; and storing the reconstituted product in a storage vessel whereby more than one baby feed bottle can be filled from one batch of baby milk.

According to a sixth aspect of the present invention there is provided a kit of parts for reconstituting the contents of a pack of dry baby milk product in a mixing vessel, said kit comprising the pack containing a pre-weighed quantity of dry baby milk product, said contents, when correctly reconstituted having a volume in excess of the volume of a single baby feeding bottle, and a set of mixing components arranged on a sprue comprising a lid for the mixing vessel, and a plunger for mixing the dry baby milk product with water in the mixing vessel; wherein the set of mixing components are linked together on the sprue via connecting strips and removed from the sprue (by cutting away the interconnecting strips) prior to use.

By providing a user with such a preweighed quantity of dry baby milk a user will not have to measure out any quantities of dry baby milk product themselves. Thus potential measurement errors are obviated.

By providing the mixing vessel with a liquid level indicator a user can easily measure out a predetermined quantity of water to which the preweighed quantity of dry baby milk can be added. This inherently increases the accuracy with which feeds for bottle fed babies are made up. Accurately reconstituted feeds ensure the baby receives precisely the recommended level of nutrients for healthy growth.

Since each batch of baby milk made provides more than one baby milk bottle full of baby milk the number of times milk must be prepared is decreased.

The baby milk can be easily reconstituted by a shaking or plunging motion thus obviating the requirement for electrical mixers, blenders or the like which therefore do not require cleaning.

The term reconstituting will be understood to involve the hydration of a dry product. It does not necessarily involve the rehydration of a product which has previously been dehydrated.

Embodiments of the present invention will now be described hereinafter with reference to the following drawings in which:

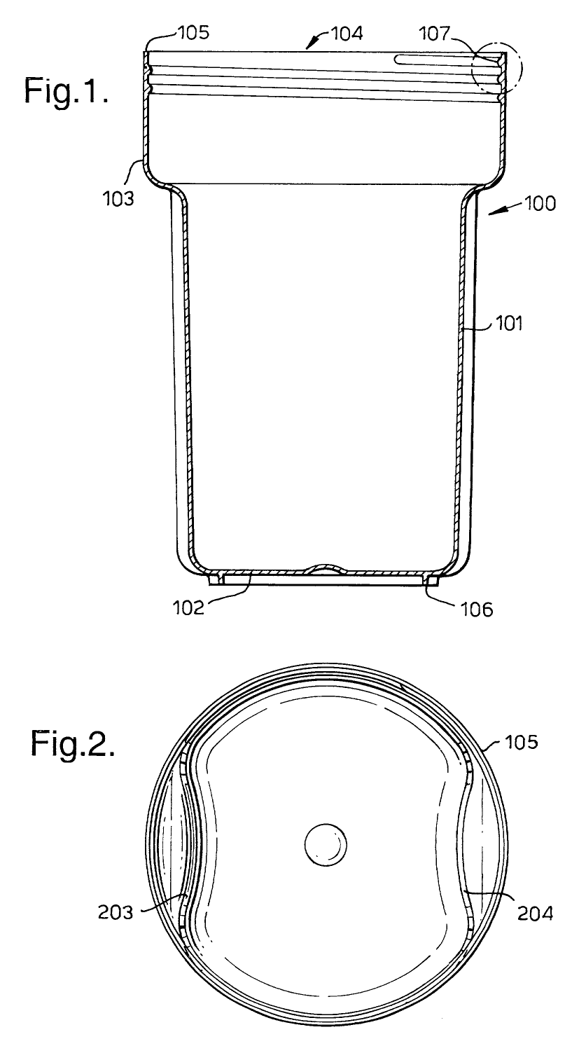

FIG. 1 shows a side view of a mixing vessel.

FIG. 2 shows a plan view of a mixing vessel.

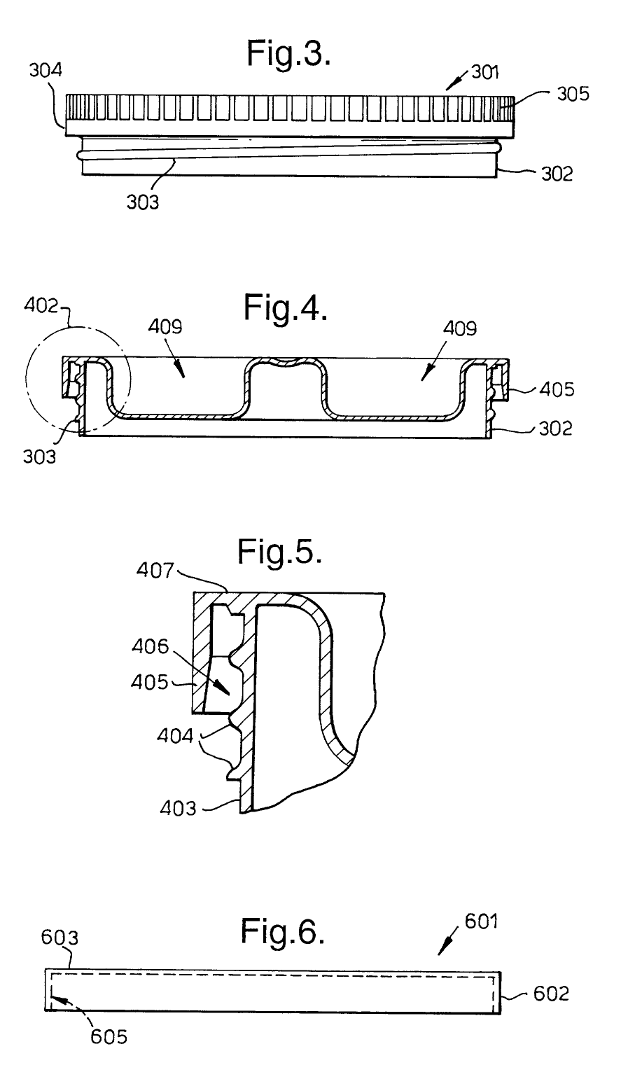

FIG. 3 shows a side view of a screw cap lid for a mixing vessel.

FIG. 4 shows a side section of the screw cap lid of FIG. 3 for a mixing vessel.

FIG. 5 shows a detail of the screw cap lid of FIG. 3 and 4 in more detail.

FIG. 6 shows a push fit lid.

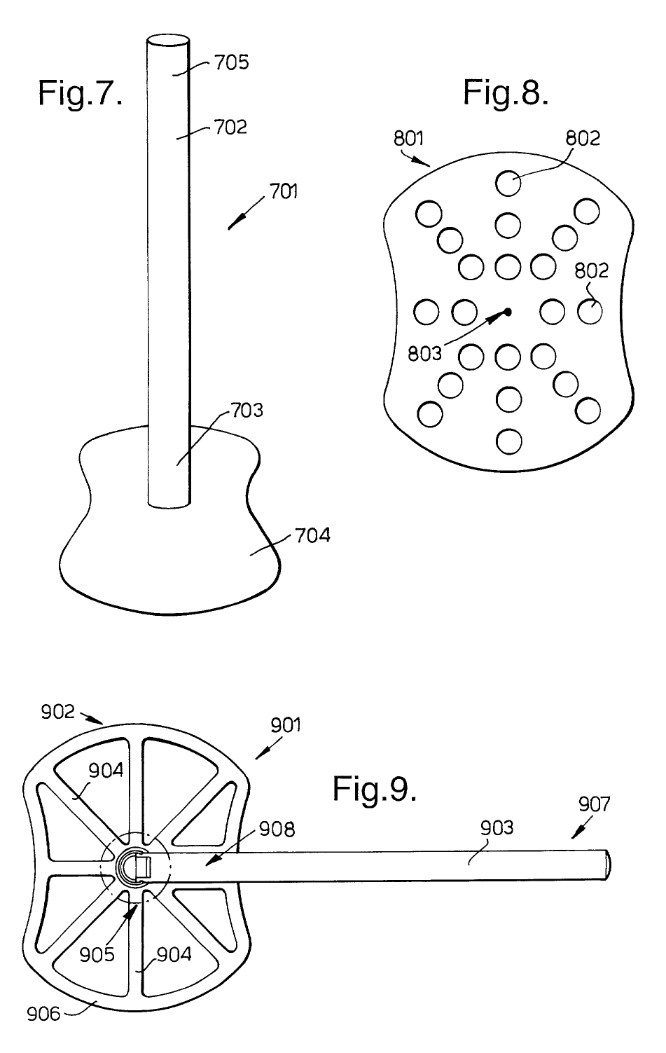

FIG. 7 shows a plunging device.

FIG. 8 shows a baffle plate.

FIG. 9 shows a hinged plunging device.

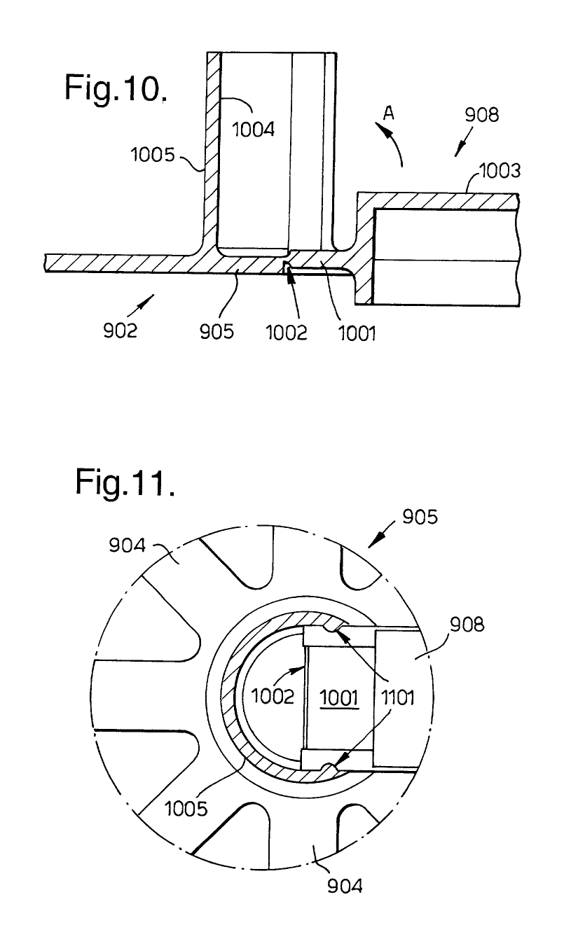

FIG. 10 shows part of the plunging device of FIG. 9 in more detail.

FIG. 11 shows a detail of the plunging device of FIGS. 9 and 10.

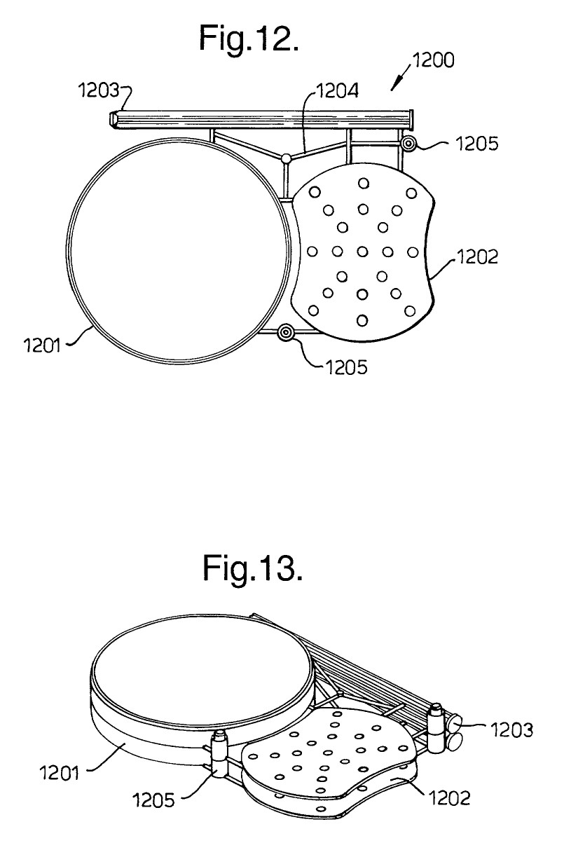

FIG. 12 shows a kit of parts including overcap and plunger.

FIG. 13 shows two kits stored together.

In the drawings like reference numerals refer to like parts.

FIG. 1 illustrates a mixing vessel 100 according to a first embodiment of the present invention. The vessel is generally cup-shaped having a cylindrical body 101 which is closed at its bottom end by a base 102. A generally cylindrical rim 103 having a larger diameter than the body provides a open mouth 104 through which water can be poured into the mixing vessel. The upper edge of the rim forms a circular lip 105 to the vessel. The base 102 of the mixer includes a short support 106 which acts as a foot for the vessel and improves the stability of the mixer when it is stood upright. The vessel is made from polypropylene. It will be understood that other rigid plastics materials could be employed.

The cylindrical body 101 of the vessel is generally fluted as may be seen more clearly in FIG. 2. The circular lip 105 of the vessel has a relatively large diameter whilst the cylindrical body 101 has a smaller radius of curvature. The vessel has parallel or tapered side walls The body is fluted on two sides 203, 204. This makes handling the vessel and pouring liquid out easier. It will be understood that more flutes could be utilised to enhance the grip offered by the vessel.

The top of the vessel around the rim 103 is threaded on the inside by screw threads 107. These enable a screw cap 301 (shown in FIG. 3) to be screwed onto the open mouth of the vessel. The cap 301 forms a lid which is liquid tight on the mixing vessel. In this way when the cap is in place liquid in the mixing vessel cannot leak or be spilled. The cap includes a neck portion 302 which fits inside the rim of the mixing vessel. The neck of the cap is itself threaded with a screw thread 303 to engage with the screw thread of the mixing vessel. By turning the cap the thread 303 engages with thread 107 to enable the cap to be screwed onto the vessel until the head 304 of the cap engages with the lip of the vessel. The mixing vessel is thus sealed in a liquid tight manner. An external finger grip 305 is moulded onto the cap to aid the screwing motion.

In order to prepare a batch of baby milk in accordance with this first embodiment a predosed quantity of baby milk powder is emptied from a sachet or pouch (not shown) into the vessel 100 which contains a quantity of water. During manufacture pre-dosing is carried out during which the quantity of the contents of the pack of baby milk is preweighed so that an exact quantity of powder is provided. In this way a user does not have to do any weighing of the baby milk product. This avoids variable quantities of dry product being measured out by a user either as a result of inaccurate counting of scoops, or as a result of the variable density of the baby milk product as a result of different scooping methods. The quantity of the dry powder product is predetermined so that when properly reconstituted the quantity of baby milk which is produced is greater than the volume of one baby feed bottle. In this way a user may prepare enough baby milk to fill a number of baby feed bottles from a single sachet of baby powder. The preprepared baby milk can be stored in the vessel 100 until it is required.

The baby milk is reconstituted by adding the predosed quantity of dry baby milk powder to a quantity of water in the mixing vessel. The amount of water added is predetermined to be sufficient to properly/correctly reconstitute baby milk powder. The amount of liquid required is indicated on the vessel either with a moulded mark or printed line (neither shown). By providing a user with only one quantity indicator the user only needs to fill the liquid up to the level indicated by the mark to provide the correct quantity of liquid. This is a relatively simple operation. It will be understood that different forms of level indicator could be used providing it is clear to a user what level of liquid should be used. The marker is provided at a level on the container such that when powder is added subsequently, the correct quantity of water is provided to correctly reconstitute that quantity and type of dry product.

The water is sterilised by boiling and then poured into—the mixing container. A temperature sensor (not shown) may also be included to allow the user to verify when the conditions are right for correctly reconstituting baby milk. This is typically when the boiled water has cooled to around 50° C. The temperature sensor is a thermochromic strip on the body of the vessel. A temperature pigment on or in the body of the vessel could alternatively be used.

The volume of the vessel is such as to provide the mixer with a capacity to make up ½ liter or 1 pint of baby milk in a single operation. This is sufficient to reconstitute a 75 g pre-weighed quantity of dry product and produces a reservoir quantity of baby milk feed sufficient to fill at least two feeding bottles each of which holds 250 ml at full capacity.

In order to complete the reconstituting process the cap 301 is screwed onto the top of the mixing vessel after the water and dry baby milk powder have been added together. After tightly screwing the lid onto the vessel a user can shake the vessel to thereby mix the two constituents of the baby milk together. This needs to be done thoroughly. The cap 301 and vessel 100 fit sufficiently tightly so there is substantially no leakage of baby milk during the shaking process.

Once the baby milk has been reconstituted it can be stored in the vessel until it is required. In this context the cap 301 provides a lid to the vessel to prevent the ingress of dirt or micro-organisms which could contaminate the prepared quantity of baby milk. In this way a user can pour a serving of preprepared baby milk from the vessel into a baby feed bottle and feed a baby whilst the remaining quantity of baby milk may be stored in the mixing container and kept in a refrigerator for later use.

The liquid tight lid of FIG. 3 is shown in cut away cross section in FIG. 4. The portion 402 of the cap shown encircled is shown more clearly in FIG. 5. The upper edge of cap 301 extends radially outwardly for a short distance and is then bent downwards to form an ear 405 which defines a U-shaped channel 406 running around the upper outer side of the cap body 302. When the cap is placed on the rim of the vessel by screwing it over the open mouth of the vessel the lip 105 of the rim extends into the U-shaped channel. The rim is thereby gripped between the outer portion of the body 302 and the inner surface of the ear 405. The upper surface of the cap 301 is not flat but rather has a central raised portion which forms a bar which extends diametrically across the cap. This forms an inner finger grip so that the bar portion can be twisted to help screw the cap open or closed. Around this the upper surface of the cap is depressed in two D-shaped troughs 409 which surround the raised portion.

The overhanging ear 405 helps prevent ingress of contaminants once the cap has been screwed onto the vessel.

An alternative to the liquid-tight lid of FIGS. 3, 4 and 5 is shown in FIG. 6 which is in accordance with a second embodiment of the present invention. FIG. 6 shows a cap 601 which can simply be pushed onto the vessel shown in FIG. 1. The cap does not therefore screw onto the vessel and accordingly has no threading. In this sense the threaded portion 107 of the mixing vessel can be omitted. The cap forms an overcap or dust cover which may be loose fitting. The cap 601 has a generally cylindrical wall portion 602 closed at the top by a circular top plate 603. The diameter of the cap 601 is selected so that the inner surface 605 of the cylindrical wall 602 engages with the outer surface of the upper portion of the rim 103 of the mixing vessel 100.

In order to mix the dry baby milk and water together the loose fitting lid of FIG. 6 cannot be used with a shaking action as liquid would leak out of the mixer. Instead a plunging device 701 is utilised as shown more clearly in FIG. 7. The plunger 701 includes a rod-shaped handle 702 which is secured at its lower end 703 to a generally figure-of-eight shaped baffle plate 704. The dimensions and shape of the baffle plate are dictated by the internal profile of the mixing vessel 100. In this way the baffle plate closely fits the inside of the vessel. If the vessel has, as an alternative, a circular cross-section ie not fluted then the baffle plate could likewise be circular. The baffle plate 704 is for regulating or diverting the flow of liquid in the mixing vessel. In particular when introduced into the mixing vessel and plunged up and down by a user the baffle plate 704 induces turbulence in the baby milk thus aiding the mixing/reconstituting process.

In order to reconstitute baby milk according to this second embodiment the vessel is first filled with water until the level of liquid reaches a predetermined level which is indicated by a level mark. The water is sterilised by boiling and then allowed to cool before pouring into the mixing container to the level mark. The temperature can then be carefully checked. Checking of the temperature may take place using a temperature indicator such as thermochromic strip (not shown) as described above. This ensures that the temperature is within a predetermined range within which optimum reconstitution of the baby milk can take place. Typically this will be in the range of 40° to 60°. Dry baby milk powder can then be added into the mixer by tearing open a sachet or pouch containing a preweighed quantity of the powder and pouring the contents into the mixing vessel. A user then places the plunger device 701 into the mixing vessel 100. The user can then agitate the plunger 701 up and down. Via this motion the baffle plate which is smaller in size than the internal diameter of the vessel, is forced up and down. This motion induces turbulence in the baby milk powder/water mixture and thus mixes them together. In this way the baby milk is reconstituted.

In order to improve the mixing performance of the baffle plate, various hole or slot configurations can be adopted. FIG. 8 shows one such configuration. The baffle plate 801 itself is generally shaped like a figure-of-eight and includes rows of holes 802. By forming holes in the plate the turbulence induced when the baffle plate is plunged up and down is increased. The baffle plate 801 can be secured to the lower portion of a handle in a manner somewhat similar to that of FIG. 7 ie by fixing the lower end of the rod 702 centrally to the baffle plate. The rod can be fixed in place by any convenient manner for example either by glueing, welding, or forming the baffle plate 801 and rod as an integral piece via injection moulding. Alternatively the baffle plate can have a hole 803 through which a stud (not shown) on the bottom of the handle can be pressed to lock the pieces together. The length of the handle 702 is selected so that the plunger may be stored in the mixing vessel between uses. The plunger is therefore shorter than the height of the vessel.

FIG. 9 shows an alternative form of baffle plate and rod handle to that of FIGS. 7 and 8. The plunger device 901 is formed from a generally figure-of-eight shaped baffle-plate 902 and a rod shaped handle 903. The baffle-plate 902 includes nine spokes 904 which radiate outwardly from a central hub zone 905. The outer ends of the spokes extend into a generally figure-of-eight shaped band 906 which forms the peripheral edge of the baffle plate 902. Shaping the baffle plate in this manner aids the mixing process.

The rod shaped handle 903 has a free end 907 which enables a user to agitate the plunger 901 up and down. The other end 908 of the handle 903 is joined to the baffle plate in a manner which can be seen more clearly in FIGS. 10 and 11. The end 908 of the handle 903 is extended to form an extended bar portion 1001. This bar is hinged to the baffle plate 902 via a hinge section 1002 which is formed by reducing the thickness of material where the bar 1001 meets the baffle plate 902. This narrow neck of material enables the handle to be rotated about the hinge point in the direction shown by arrow A in FIG. 10. This enables the handle 903 and baffle plate 902 to be manufactured in one piece (via injection moulding or other such process) and flat packed as will be described further hereinafter. When a user wishes to assemble the plunger 901 for use the rod is bent in the direction of arrow A until the surface 1003 of the end 908 of the handle engages with abutment surface 1004 of a horseshoe-shaped or U-shaped upward extension 1005 of the central zone 905 of the baffle plate. The handle and baffle plate are provided with a securing device to lock the handle in the upright position once it has been hinged upwardly. These locking means can take the form of securing nodes 1101 which extend outwardly from the ends of the upward extension abutment member 1005. In that position the handle extends substantially at 90° from the baffle plate and is gripped in position by the nodes 1101 engaging against its outer surface.

The upward extension 1005 of the baffle plate is U-shaped or horseshoe-shaped and has a gap to allow the handle to be correctly positioned. The baffle plate also has a gap which allows the handle to be stored in a “flat” format. FIG. 11 shows an enlarged view of the central part of the baffle plate 902 of FIG. 9.

In order to provide the user with a clean sterile cap and plunger for use with the mixing vessel a kit 1200 of component parts comprising a cap 1201, a baffle plate 1202 and a handle 1203 can be produced via an injection moulding process. Such a kit can be seen in FIG. 12. In order to assemble the plunger and remove the cap, 1201 a user need simply cut away the required pieces from the unwanted strips 1204 of the sprue which may then be discarded. As an alternative to cutting away unrequired parts severable links could be provided which could be snapped off by a user and then discarded. Stacking elements 1205 are included as may be seen more clearly in FIG. 13 so that the parts for mixing more than one batch of baby milk can be conveniently stored together. This is particularly convenient for the manufacturer of these kits. The plunger is provided by means of two separate components, a rod shaped handle and a baffle plate. The rod is attached to the baffle plate by inserting a spigot into a central hole of the-baffle plate and twisting through 90°. Protuberances on the baffle plate (not shown) engage with the rod spigot preventing the baffle plate from twisting loose during use. The protuberances are located on both sides of the baffle plate so that it does not matter which way the handle and baffle plate are assembled. A user is required to clean the mixing vessel and component parts, and sterilise these between each session of making up milk. The baffle plate and handle are disassembled prior to cleaning and reassembled before sterilisation.

In one instance, a pack solely containing a mixing vessel and a kit like the one shown in FIGS. 12 and 13 could be sold or offered to users. Refill packs containing just the dry baby milk product in sachets or pouches could also subsequently be provided for sale. The amount of powder contained in these “refill” sachets or pouches may be more or less than 75 g of baby milk product.

Although the above description refers throughout to the reconstitution of a dry milk product, it will be understood that the invention could equally be used with a liquid concentrate form of baby milk which is diluted by adding a pre-prepared quantity of the concentrate to the predetermined quantity of water. It will also be understood that rather than a plunger, forks, spoons or other paddles could be used for reconstitution.

It will be understood that modifications could be made to the above-described examples without departing from the scope of the invention.

1. An accurate method of preparing baby milk by reconstituting the contents of a pack of dry baby milk product in a mixing vessel comprising the steps of:
adding water into the vessel until the liquid level reaches a liquid level indicator;
adding the contents of the pack into the vessel;
placing a plunger having a baffle plate at an end of a handle into the vessel; and
agitating the plunger thereby reconstituting a volume of baby milk sufficient to make up two or more feeds for infants aged 0-24 months which exceeds the volume of a baby feed bottle.

2. A method of preparing baby milk by reconstituting the contents of a pack of dry baby milk product in a mixing vessel comprising the steps of:
adding water into the vessel until the liquid level reaches a liquid level indicator;
adding the contents of the pack into the vessel; and
screwing a liquid-tight lid onto the vessel and shaking thereby reconstituting a volume of baby milk sufficient to make up two or more feeds for infants aged 0-24 months.

3. A method according to any one of claims 1 or 2 further comprising the steps of removing said dry product from a sealed pack comprising a sachet or pouch prior to adding the contents of the sachet or pouch into the mixing vessel.

4. Apparatus for preparing baby milk by reconstituting the contents of a pack of dry baby milk product said contents, when correctly reconstituted, having a volume in excess of the volume of a baby feed bottle, said apparatus comprising:
a mixing vessel including a level-indicator to indicate when a predetermined volume of water is in the mixing vessel;
a lid; and
a plunging device which includes a baffle plate disposed at an end of a handle to enable a user to plunge the baffle plate in the mixing vessel; wherein the contents of the pack are mixable with said predetermined volume of water in the mixing vessel to thereby reconstitute the baby milk accurately and with ease.

5. Apparatus for preparing baby milk by reconstituting the contents of a pack of dry baby milk product said contents, when correctly reconstituted, having a volume in excess of the volume of a baby feed bottle, said apparatus comprising:
a mixing vessel including a level-indicator to indicate when a predetermined volume of water is in the mixing vessel; and
a tight fitting lid having a screw thread which can be screwed onto the vessel in a substantially liquid-tight manner; wherein the contents of the pack are mixable with said predetermined volume of water in the mixing vessel to thereby reconstitute the baby milk accurately and with ease.

6. Apparatus according to claims 4 or 5 wherein said baffle plate includes slits, flexible paddles or an arrangement of holes.

7. Apparatus according to any one of claims 4 to 6 wherein said mixing vessel is substantially cup-shaped having a generally cylindrical body portion closed at one end by a base portion and open at its other end thereby to form an open mouth to the vessel through which liquid can be poured into the mixing vessel.

8. Apparatus according to any one of claims 4 to 7 further comprising:
a sealed pack containing a pre-dosed quantity of dry product.

9. Apparatus according to claim 8 wherein said sealed pack further comprises a tear strip to enable a user to tear open the pack.

10. Apparatus according to any one of claims 4 to 9 including:
a lid for said mixing vessel which prevents contamination of reconstituted baby milk stored in the vessel.

11. Apparatus according to claim 4 or 5 wherein said level-indicator is a mark moulded or printed on the side of the mixing vessel.

12. Apparatus according to claim 8 or any claim dependent therefrom in which said pack is a sachet or pouch.

13. Apparatus according to claim 4 or 5 wherein said mixing vessel is manufactured from a rigid plastics material.

14. Apparatus according to claim 13 in which said rigid plastics material is polypropylene.

15. Apparatus according to claim 4 or 5 further comprising:
a temperature indicator for providing a user with an indication that liquid in the mixing vessel is at a desired temperature.

16. Apparatus according to claim 15 wherein said temperature indicator is a thermochromic strip or pigment on or in the mixing vessel.

17. Apparatus according to claim 4 or 5 wherein the capacity of said vessel is between 800 and 1200 milliliters.

18. A process of preparing a batch of baby milk comprising:
weighing a quantity of dry baby milk product which, when correctly reconstituted has a volume in excess of the volume of a baby feed bottle;
packing said weighed quantity in a pack;
reconstituting the dry baby milk product; and
storing the reconstituted product in a storage vessel whereby more than one baby feed bottle can be filled from one batch of baby milk.

19. A kit of parts for reconstituting the contents of a pack of dry baby milk product in a mixing vessel, said kit comprising:
the pack containing a pre-weighed quantity of dry baby milk product, said contents, when correctly reconstituted having a volume in excess of the volume of a baby feeding bottle; and
a set of mixing components arranged on a sprue comprising:
a lid for the mixing vessel; and
a plunger for mixing the dry baby milk product with water in the mixing vessel; wherein the set of mixing components are linked together on the sprue via connecting strips which are removed from the sprue prior to use.

20. The kit of claim 19 wherein said plunger comprises a separate handle and baffle plate which are connected together via snap strips in said component set prior to use.

21. The kit of claim 19 wherein said plunger comprises a separate handle and baffle plate which are connected together via severable links in said component set prior to use.

22. The kit of any one of claims 19 to 21 wherein the components in said component set are integrally formed via injection moulding.

23. The kit of any one of claims 19 to 22 wherein the pack and component set are disposed in a sealed container prior to use.

24. A method for preparing baby milk by reconstituting a dry baby milk product substantially as herein described with reference to and as illustrated in the accompanying drawings.

25. Apparatus for reconstituting a dry baby milk product, constructed and arranged substantially as herein described with reference to and as illustrated in the accompanying drawings.
